(19) United States
(12) Patent Application Publication
(10) Pub. No.: US 2024/0000109 A1
(43) Pub. Date: Jan. 4, 2024

(54) OLIGOSACCHARIDE FORMULATION

(71) Applicant: DSM IP ASSETS B.V., Heerlen (NL)

(72) Inventors: Ivan de Jesus GAYTAN PEREZ, Kaiseraugst (CH); John Michael GEREMIA, Kaiseraugst (CH); Christine GOTHSCHECK, Kaiseraugst (CH); Josef Theodor HOERMANSPERGER, Kaiseraugst (CH); Marta PAGLIARI, Kaiseraugst (CH); Tony STEINEBRUNNER, Kaiseraugst (CH); Patricia DRYJA, Kaiseraugst (CH); Olivia Brigitte VIDONI, Kaiseraugst (CH); Alexandru ZABARA, Kaiseraugst (CH)

(21) Appl. No.: 18/255,438

(22) PCT Filed: Dec. 2, 2021
(86) PCT No.: PCT/EP2021/083996

§ 371 Date: Jun. 1, 2023

Related U.S. Application Data
(60) Provisional application No. 63/194,242, filed on May 28, 2021.

(30) Foreign Application Priority Data
Dec. 3, 2020 (EP) 20211669.5

(51) Int. Cl. A23K 20/163; C08B 37/00; A23K 20/28

(52) U.S. Cl. CPC A23K 20/163; C08B 37/0087; C08B 37/006; C08B 37/0006; A23K 20/28

(57) ABSTRACT

The present invention relates to storage-stable formulations of oligosaccharide preparations suitable for use in nutritional compositions such as animal feed.

### BACKGROUND OF THE INVENTION

Oligosaccharides are a heterogeneous group of carbohydrates with various degrees of polymerizations. Oligosaccharides compositions may be produced naturally, e.g., in milk, or synthesized through enzymatic or chemical processes. Depending on the process of manufacture, the resultant oligosaccharide compositions may possess distinct chemical, biological and/or physical properties. Enzymatic hydrolysis of longer chain oligosaccharides and polysaccharides may produce oligosaccharides through specific cleavages under mild reaction conditions. However, the use of enzymes in industrial process is limited by their thermostability, and enzymatic methods may generate degradation side products that cause metabolic problems when consumed by poultry, swine, and other livestock. On the other hand, chemical hydrolysis of longer chain oligosaccharides and polysaccharides may require harsh reaction conditions, and it is difficult to control the chemical and/or physical properties of oligosaccharides produced via the chemical hydrolysis process. Accordingly, there remains a need for manufacturing oligosaccharide compositions with desired properties.

Oligosaccharide preparations, which may generally include monosaccharides, oligosaccharides, polysaccharides, functionalized oligosaccharides, or their combinations, are used as additives in nutritional compositions such as animal feed. The addition of oligosaccharide preparations may improve the health and performance of the animal.

Oligosaccharide preparations according to the invention are synthetic oligosaccharide preparations comprising at least n fractions of oligosaccharides each having a distinct degree of polymerization selected from 1 to n (DP1 to DPn fractions), wherein n is an integer greater or equal to 2; and wherein each fraction comprises from 1% to 90% anhydro-subunit containing oligosaccharides by relative abundance as measured by mass spectrometry. Preferred oligosaccharide preparations according to the invention are defined below.

Methods of manufacturing oligosaccharide preparations according to the invention are described in WO 2020/097458, WO 2016/007778 and characterized by the step of heating an aqueous composition comprising one or more feed sugars and a catalyst to a temperature and for a time sufficient to induce polymerization.

It is challenging to add such oligosaccharide preparations to animal feed because of their physical properties. The preparations manufactured by methods disclosed in WO 2020/097458 are in liquid form. As a result, a need exists for a method of developing a solid product form which overcomes storage and handling problems of liquid feed additives and which additionally has a good flowability and storage stability, is stable against humidity and can easily be admixed with other components commonly used in animal feed products, in particular for poultry and swine.

Surprisingly, it has been found that an oligosaccharide preparation according to the invention is effectively formulated if absorbed on a silica based product having an average particle size D(0,5) of ≤3000 μm, preferably ≤2000 μm, more preferably ≤1200 μm. D(0,5) means Particle Size Distribution (PSD) according to standard definitions and D(0,5) is in the following also called “D”.

Thus, in a first embodiment the present invention relates to a powderous formulation characterized by
(i) at least 20 weight-% (wt-%), based on the total weight of the powderous formulation, of an oligosaccharide preparation comprising at least n fractions of oligosaccharides each having a distinct degree of polymerization selected from 1 to n (DP1 to DPn fractions), wherein n is an integer greater than 2; and wherein each fraction comprises from 1% to 90% anhydro-subunit containing oligosaccharides by relative abundance as measured by mass spectrometry,
(ii) 0 to 25 wt-%, based on the total weight of the powderous formulation, of water and/or an additive, and
(iii) at least 25 wt-%, based on the total weight of the powderous formulation, of a silica based adsorbate having an average particle size D≤3000 μm.

It is well understood that the compositions according to the present invention are storage-stable, reduce the sensitivity of the oligosaccharide preparation to water uptake and are free flowable.

The formulations according to the present invention are powders, which depending on the process of production as well as on the storage conditions may comprise some water. The water content is usually below 25 wt-%, preferably below 10 wt-% based on the total weight of the formulation. Therefore, a further embodiment of the present invention relates to formulations as described above, wherein 0 to 21 wt-%, based on the total weight of the formulation, of water is present.

The formulations according to the present invention may furthermore contain small amounts of customary additives commonly used in the preparation of powderous formulations for feed application. Therefore, a further embodiment of the present invention relates to formulations according to the present invention, wherein 0 to 5 wt-%, based on the total weight of the formulation, of an additive is present.

It is clear that in all embodiments of the present invention the addition of all the wt.-% always adds up to 100. However, it cannot be excluded that small amount of impurities or additives may be present such as e.g. in amounts of less than 5 wt.-%, preferably less than 3 wt.-% which are e.g. introduced via the respective raw materials or processes used.

### SUMMARY OF THE INVENTION

Provided herein is a solid formulation of synthetic oligosaccharide preparations as defined above adsorbed on a Silica based product.

Silica is such is a well-known carrier material in the feed and food industry and refers to white microspheres of amorphous silica (also referred to as silicone dioxide) and is available in a great variety of particle sizes. Particular suitable silica according to the present invention is amorphous precipitated silica (AS) having a particle size of 350 μm such as e.g. Ibersil D-250 from IQE Group, Sipernat 2200 from Evonik or Tixosil 68 from Solvay or Zeofree 5170 from Huber.

Another Silica based product is Diatomaceous earth—also known as D.E., diatomite—it is a naturally occurring, soft, siliceous sedimentary rock that is easily crumbled into a fine powder, with white colour when natural. It has a particle size ranging from less than 3 μm to more than 1 mm. Depending on the granularity, this powder can have an abrasive feel, similar to pumice powder, and has a low density as a result of its high porosity. The typical chemical composition of oven-dried diatomaceous earth is 80-90% silica, with 2-4% alumina (attributed mostly to clay minerals) and 0.5-2% iron oxide.

Preferably in all embodiments of the present invention the silica based product according to the present invention has an average (mean) particle size D(0,5) selected in the range of 100 to 800 μm, more preferably in the range of 200 to 500 μm and most preferably in the range of 200 to 350 μm.

Additional aspects and advantages of the present disclosure will become readily apparent to those skilled in this art from the following detailed description, wherein only illustrative embodiments of the present disclosure are shown and described.

### DETAILED DESCRIPTION OF THE INVENTION

Described herein are oligosaccharide preparations and solid compositions that comprise such oligosaccharide preparations. Further described herein are methods of producing the oligosaccharide preparations and solid compositions.

### I. Definitions

As used herein, the term “anhydro-subunit” may be a product of reversible thermal dehydration of a monosaccharide (or monosaccharide subunit) or a sugar caramelization product. For example, an “anhydro-subunit” may be an anhydro-monosaccharide such as anhydro-glucose. As another example, an “anhydro-subunit” may be linked with one or more regular or anhydro-monosaccharide subunits via glycosidic linkage.

As used herein, the term “oligosaccharide preparation” may refer to a preparation that comprises one or more oligosaccharides.

As used herein, an “oligosaccharide” or “oligomer” may refer to a monosaccharide or a compound containing two or more monosaccharide subunits linked by glycosidic bonds. An “oligosaccharide” may also refer to an anhydro-monosaccharide or a compound containing two or more monosaccharide subunits, where at least one monosaccharide unit is replaced by an anhydro-subunit. An “oligosaccharide” may be optionally functionalized. As used herein, the term “oligosaccharide” encompasses all species of the oligosaccharide, wherein each of the monosaccharide subunit in the oligosaccharide is independently and optionally functionalized and/or replaced with its corresponding anhydro-monosaccharide subunit.

As used herein, a “gluco-oligosaccharide” may refer to a glucose or a compound containing two or more glucose monosaccharide subunits linked by glycosidic bonds. A “gluco-oligosaccharide” may also refer to an anhydro-glucose or a compound containing two or more glucose monosaccharide subunits linked by glycosidic bonds, wherein at least one monosaccharide subunit is replaced with an anhydro-glucose subunit. Similarly, a “galacto-oligosaccharide” may refer to a galactose or a compound containing two or more galactose monosaccharide subunits linked by glycosidic bonds. A “galacto-oligosaccharide” may also refer to an anhydro-galactose or a compound containing two or more galactose monosaccharide subunits linked by glycosidic bonds, wherein at least one monosaccharide subunit is replaced with an anhydro-galactose subunit.

As used herein, a “gluco-galacto-oligosaccharide” may refer to a compound that is produced from a complete or incomplete sugar condensation reaction of glucose and galactose. For example, a gluco-galactose-oligosaccharide may be a gluco-oligosaccharide, a galacto-oligosaccharide, or a compound containing one or more glucose monosaccharide subunits and one or more galactose monosaccharide subunits linked by glycosidic bonds. Accordingly, in some embodiments, a gluco-galactose-oligosaccharide preparation comprises gluco-oligosaccharides, galacto-oligosaccharides, and compounds containing one or more glucose monosaccharide subunits and one or more galactose monosaccharide subunits linked by glycosidic bonds. In some embodiments, a gluco-galactose-oligosaccharide preparation comprises gluco-oligosaccharides and compounds containing one or more glucose monosaccharide subunits and one or more galactose monosaccharide subunits linked by glycosidic bonds. In some embodiments, a gluco-galactose-oligosaccharide preparation comprises galacto-oligosaccharides and compounds containing one or more glucose monosaccharide subunits and one or more galactose monosaccharide subunits linked by glycosidic bonds. In some embodiments, a gluco-galactose-oligosaccharide preparation comprises compounds containing one or more glucose monosaccharide subunits and one or more galactose monosaccharide subunits linked by glycosidic bonds.

Additionally, a gluco-galactose-oligosaccharide may be a gluco-oligosaccharide, a galacto-oligosaccharide, or a compound containing one or more glucose monosaccharide subunits and one or more galactose monosaccharide subunits linked by glycosidic bonds, wherein at least one of the monosaccharide subunits is replaced with its respective anhydro-monosaccharide subunit.

Similarly, a gluco-galacto-xylo-oligosaccharide may refer to a compound produced by the condensation reaction of glucose, galactose, and xylose. An oligosaccharide preparation comprising gluco-galacto-xylo-oligosaccharides may comprise gluco-galactose-oligosaccharides, gluco-xylo-oligosaccharides, galacto-xylo-oligosaccharides, and compounds containing one or more glucose monosaccharide subunits, one or more xylose monosaccharide subunits, and one or more galactose monosaccharide subunits linked by glycosidic bonds.

As used herein, the term “monosaccharide unit” and “monosaccharide subunit” may be used interchangeably, unless suggested otherwise. A “monosaccharide subunit” may refer to a monosaccharide monomer in an oligosaccharide. For an oligosaccharide having a degree of polymerization of 1, the oligosaccharide may be referred to as a monosaccharide subunit or monosaccharide. For an oligosaccharide having a degree of polymerization higher than 1, its monosaccharide subunits are linked via glycosidic bonds.

As used herein, the term “regular monosaccharide” may refer to a monosaccharide that does not contain an anhydro-subunit. The term “regular disaccharide” may refer to a disaccharide that does not contain an anhydro-subunit. Accordingly, the term “regular subunit” may refer to a subunit that is not an anhydro-subunit.

The term “relative abundance” or “abundance,” as used herein, may refer to the abundance of a species in terms of how common or rare the species exists. For example, a DP1 fraction comprising 10% anhydro-subunit containing oligosaccharides by relative abundance may refer to a plurality of DP1 oligosaccharides, wherein 10%, by number, of the DP1 oligosaccharides are anhydro-monosaccharides.

As used herein, the singular forms “a,” “and,” and “the” include plural referents unless the context clearly dictates otherwise. Thus, for example, reference to “an agent” includes a plurality of such agents, and reference to “the oligosaccharide” includes reference to one or more oligosaccharides (or to a plurality of oligosaccharides) and equivalents thereof known to those skilled in the art, and so forth.

When ranges are used herein for physical properties, such as molecular weight, or chemical properties, such as chemical formulae, all combinations and subcombinations of ranges and specific embodiments therein are intended to be included. The term “about” when referring to a number or a numerical range means that the number or numerical range referred to is an approximation within experimental variability (or within statistical experimental error), and thus the number or numerical range, in some instances, will vary between 1% and 15% of the stated number or numerical range.

### II. Synthetic Oligosaccharide Preparations

In some embodiments, the disclosed oligosaccharide preparation comprises at least n fractions of oligosaccharides each having a distinct degree of polymerization selected from 1 to n (DP1 to DPn fractions), wherein n is an integer greater than or equal to 2. In some embodiments, n is an integer greater than 2. In some embodiments, each of the 1 to n fraction in the oligosaccharide preparation comprises from 1% to 90% anhydro-subunit containing oligosaccharides by relative abundance as measured by mass spectrometry. In some embodiments, the relative abundance of oligosaccharides in each fraction decreases monotonically with its degree of polymerization

In some embodiments, the relative abundance of oligosaccharides in at least 5, 10, 20, or 30 DP fractions decreases monotonically with its degree of polymerization. In some embodiments, the relative abundance of oligosaccharides in each of the n fractions decreases monotonically with its degree of polymerization.

In some embodiments, n is at least 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100.

In some embodiments, at least one fraction comprises less than 80%, 70%, 60%, 50%, 40%, 30%, 20%, 19%, 18%, 17%, 16%, 15%, 14%, 13%, 12%, 11%, 10%, 9%, 8%, 7%, 6%, 5%, 4%, 3%, or 2% anhydro-subunit containing oligosaccharides by relative abundance.

In some embodiments, the oligosaccharide preparation comprises less than 80%, 70%, 60%, 50%, 40%, 30%, 20%, 19%, 18%, 17%, 16%, 15%, 14%, 13%, 12%, 11%, 10%, 9%, 8%, 7%, 6%, 5%, 4%, 3%, or 2% anhydro-subunit containing oligosaccharides by relative abundance.

In some embodiments, each fraction comprises less than 80%, 70%, 60%, 50%, 40%, 30%, 20%, 19%, 18%, 17%, 16%, 15%, 14%, 13%, 12%, 11%, 10%, 9%, 8%, 7%, 6%, 5%, 4%, 3%, or 2% anhydro-subunit containing oligosaccharides by relative abundance.

In some embodiments, at least one fraction comprises less than 10%, 9%, 8%, 7%, 6%, 5%, 4%, 3%, or 2% anhydro-subunit containing oligosaccharides by relative abundance. In some embodiments, the oligosaccharide preparation comprises less than 10%, 9%, 8%, 7%, 6%, 5%, 4%, 3%, or 2% anhydro-subunit containing oligosaccharides by relative abundance. In some embodiments, each fraction comprises less than 10%, 9%, 8%, 7%, 6%, 5%, 4%, 3%, or 2% anhydro-subunit containing oligosaccharides by relative abundance.

In some embodiments, at least one fraction comprises greater than 2%, 3%, 4%, 5%, 6%, 7%, 8%, 9%, 10%, 11%, 12%, 13%, 14%, 15%, 16%, 17%, 18%, 19%, 20%, 30%, 40%, 50%, 60%, 70%, or 80% anhydro-subunit containing oligosaccharides by relative abundance. In some embodiments, the oligosaccharide preparation comprises greater than 2%, 3%, 4%, 5%, 6%, 7%, 8%, 9%, 10%, 11%, 12%, 13%, 14%, 15%, 16%, 17%, 18%, 19%, 20%, 30%, 40%, 50%, 60%, 70%, or 80% anhydro-subunit containing oligosaccharides by relative abundance. In some embodiments, each fraction comprises greater than 2%, 3%, 4%, 5%, 6%, 7%, 8%, 9%, 10%, 11%, 12%, 13%, 14%, 15%, 16%, 17%, 18%, 19%, 20%, 30%, 40%, 50%, 60%, 70%, or 80% anhydro-subunit containing oligosaccharides by relative abundance.

In some embodiments, at least one fraction comprises greater than 20%, 21%, 22%, 23%, 24%, or 25% anhydro-subunit containing oligosaccharides by relative abundance. In some embodiments, the oligosaccharide preparation comprises greater than 20%, 21%, 22%, 23%, 24%, or 25% anhydro-subunit containing oligosaccharides by relative abundance. In some embodiments, each fraction comprises greater than 20%, 21%, 22%, 23%, 24%, or 25% anhydro-subunit containing oligosaccharides by relative abundance.

In some embodiments, more than 99%, 95%, 90%, 85%, 80%, 75%, 70%, 65%, 60%, 55%, 50%, 45%, 40%, 35%, or 30% of the anhydro-subunit containing oligosaccharides have only one anhydro-subunit.

In some embodiments, the oligosaccharide preparation has a DP1 fraction content from 1 to 40% by relative abundance. In some embodiments, the oligosaccharide preparation has a DP2 fraction content from 1 to 35% by relative abundance. In some embodiments, the oligosaccharide preparation has a DP3 fraction content from 1 to 30% by relative abundance. In some embodiments, the oligosaccharide preparation has a DP4 fraction content from 0.1 to 20% by relative abundance. In some embodiments, the oligosaccharide preparation has a DP5 fraction content from 0.1 to 15% by relative abundance.

In some embodiments, the ratio of DP2 fraction to DP1 fraction is 0.02-0.40 by relative abundance. In some embodiments, the ratio of DP3 fraction to DP2 fraction is 0.01-0.30 by relative abundance.

In some embodiments, the aggregate content of DP1 and DP2 fractions in the oligosaccharide preparation is less than 50, 30, or 10% by relative abundance.

In some embodiments, the oligosaccharide preparation comprises at least 10³, 10⁴, 10⁵, 10⁶ or 10⁹ different oligosaccharide species.

In some embodiments, two or more independent oligosaccharides comprise different anhydro-subunits.

In some embodiments, the oligosaccharide preparation comprises one or more anhydro-subunits that are products of reversible thermal dehydration of monosaccharides.

In some embodiments, the oligosaccharide preparation comprises one or more anhydro-glucose, anhydro-galactose, anhydro-mannose, anhydro-allose, anhydro-altrose, anhydro-gulose, anhydro-indose, anhydro-talose, anhydro-fructose, anhydro-ribose, anhydro-arabinose, anhydro-rhamnose, anhydro-lyxose, or anhydro-xylose subunits. In some embodiments, the oligosaccharide preparation comprises one or more anhydro-glucose, anhydro-galactose, anhydro-mannose, or anhydro-fructose subunits.

In some embodiments, the oligosaccharide preparation comprises one or more 1,6-anhydro-β-D-glucofuranose or 1,6-anhydro-β-D-glucopyranose subunits. In some embodiments, the oligosaccharide preparation comprises both 1,6-anhydro-β-D-glucofuranose and 1,6-anhydro-β-D-glucopyranose anhydro-subunits.

In some embodiments, a ratio of 1,6-anhydro-β-D-glucofuranose to 1,6-anhydro-β-D-glucopyranose is from about 10:1 to 1:10, 9:1 to 1:10, 8:1 to 1:10, 7:1 to 1:10, 6:1 to 1:10, 5:1 to 1:10, 4:1 to 1:10, 3:1 to 1:10, 2:1 to 1:10, 10:1 to 1:9, 10:1 to 1:8, 10:1 to 1:7, 10:1 to 1:6, 10:1 to 1:5, 10:1 to 1:4, 10:1 to 1:3, 10:1 to 1:2, or 1:1 to 3:1 in the oligosaccharide reparation. In some embodiments, the ratio of 1,6-anhydro-β-D-glucofuranose to 1,6-anhydro-β-D-glucopyranose is about 10:1, 9:1, 8:1, 7:1, 6:1, 5:1, 4:1, 3:1, 2:1, 1:1, 1:2, 1:3, 1:4, 1:5, 1:6, 1:7, 1:8, 1:8, 1:9, or 1:10 within the oligosaccharide preparation. In some embodiments, the ratio of 1,6-anhydro-β-D-glucofuranose to 1,6-anhydro-β-D-glucopyranose is about 2:1 in the oligosaccharide preparation.

In some embodiments, the ratio of 1,6-anhydro-β-D-glucofuranose to 1,6-anhydro-β-D-glucopyranose is about from 10:1 to 1:10, 9:1 to 1:10, 8:1 to 1:10, 7:1 to 1:10, 6:1 to 1:10, 5:1 to 1:10, 4:1 to 1:10, 3:1 to 1:10, 2:1 to 1:10, 10:1 to 1:9, 10:1 to 1:8, 10:1 to 1:7, 10:1 to 1:6, 10:1 to 1:5, 10:1 to 1:4, 10:1 to 1:3, 10:1 to 1:2, or 1:1 to 3:1 in each fraction. In some embodiments, the ratio of 1,6-anhydro-β-D-glucofuranose to 1,6-anhydro-β-D-glucopyranose is about 10:1, 9:1, 8:1, 7:1, 6:1, 5:1, 4:1, 3:1, 2:1, 1:1, 1:2, 1:3, 1:4, 1:5, 1:6, 1:7, 1:8, 1:8, 1:9, or 1:10 in each fraction. In some embodiments, the ratio of 1,6-anhydro-β-D-glucofuranose to 1,6-anhydro-β-D-glucopyranose is about 2:1 in each fraction.

In some embodiments, at least 1%, 5%, 10%, 20%, 30%, 40%, 50%, 60%, 70%, 80%, or 90% of anhydro-subunits are selected from a group consisting of 1,6-anhydro-β-D-glucofuranose and 1,6-anhydro-β-D-glucopyranose.

In some embodiments, the weight average molecular weight of the preparation is about from 300 to 5000 g/mol, 500 to 5000 g/mol, 700 to 5000 g/mol, 500 to 2000 g/mol, 700 to 2000 g/mol, 700 to 1500 g/mol, 300 to 1500 g/mol, 300 to 2000 g/mol, 400 to 1300 g/mol, 400 to 1200 g/mol, 400 to 1100 g/mol, 500 to 1300 g/mol, 500 to 1200 g/mol, 500 to 1100 g/mol, 600 to 1300 g/mol, 600 to 1200 g/mol, or 600 to 1100 g/mol.

In some embodiments, the number average molecular weight of the preparation is about from 300 to 5000 g/mol, 500 to 5000 g/mol, 700 to 5000 g/mol, 500 to 2000 g/mol, 700 to 2000 g/mol, 700 to 1500 g/mol, 300 to 1500 g/mol, 300 to 2000 g/mol, 400 to 1000 g/mol, 400 to 900 g/mol, 400 to 800 g/mol, 500 to 900 g/mol, or 500 to 800 g/mol.

### Degree of Polymerization (DP) Distribution

A distribution of the degree of polymerization of the oligosaccharide preparation may be determined by any suitable analytical method and instrumentation, including but not limited to end group method, osmotic pressure (osmometry), ultracentrifugation, viscosity measurements, light scattering method, size exclusion chromatography (SEC), SEC-MALLS, field flow fractionation (FFF), asymmetric flow field flow fractionation (A4F), high-performance liquid chromatography (HPLC), and mass spectrometry (MS). For example, the distribution of the degree of polymerization may be determined and/or detected by mass spectrometry, such as MALDI-MS, LC-MS, or GC-MS. For another example, the distribution of the degree of polymerization may be determined and/or detected by SEC, such as gel permeation chromatography (GPC). As yet another example, the distribution of the degree of polymerization may be determined and/or detected by HPLC, FFF, or A4F. In some embodiments, the distribution of the degree of polymerization is determined and/or detected by MALDI-MS. In some embodiments, the distribution of the degree of polymerization is determined and/or detected by GC-MS or LC-MS. In some embodiments, the distribution of the degree of polymerization is determined and/or detected by SEC. In some embodiments, the distribution of the degree of polymerization is determined and/or detected by HPLC. In some embodiments, the distribution of the degree of polymerization is determined and/or detected by a combination of analytical instrumentations such as MALDI-MS and SEC. In some embodiments, the degree of polymerization of the oligosaccharide preparation may be determined based on its molecular weight and molecular weight distribution (for a more detailed description see WO 2020/097458).

### Anhydro-Subunit Level

In some embodiments, each of the n fractions of oligosaccharides independently comprises an anhydro-subunit level. For instance, in some embodiments, the DP1 fraction comprises 10% anhydro-subunit containing oligosaccharides by relative abundance, and the DP2 fraction comprises 15% anhydro-subunit containing oligosaccharides by relative abundance. For another example, in some embodiments, DP1, DP2, and DP3 fraction each comprises 5%, 10%, and 2% anhydro-subunit containing oligosaccharides by relative abundance, respectively. In other embodiments, two or more fractions of oligosaccharides may comprise similar level of anhydro-subunit containing oligosaccharides. For example, in some embodiments, the DP1 and DP3 fraction each comprises about 5% anhydro-subunit containing oligosaccharides by relative abundance.

The level of anhydro-subunits may be determined by any suitable analytical methods, such as nuclear magnetic resonance (NMR) spectroscopy, mass spectrometry, HPLC, FFF, A4F, or any combination thereof. In some embodiments, the level of anhydro-subunits is determined, at least in part, by mass spectrometry such as MALDI-MS. In some embodiments, the level of anhydro-subunits may be determined, at least in part, by NMR. In some embodiments, the level of anhydro-subunits may be determined, at least in part, by HPLC. For example, in some embodiments, the level of anhydro-subunits may be determined by MALDI-MS, as illustrated in more detail in WO 2020/097458.

### Glycosidic Linkages

In some embodiments, the oligosaccharide preparations used in the methods described herein comprise a variety of glycosidic linkages. The type and distribution of the glycosidic linkages may depend on the source and manufacturing method of the oligosaccharide preparation. In some embodiments, the type and distribution of various glycosidic linkages may be determined and/or detected by any suitable methods known in the art such as NMR. For example, in some embodiments, the glycosidic linkages are determined and/or detected by proton NMR, carbon NMR, 2D NMR such as 2D JRES, HSQC, HMBC, DOSY, COSY, ECOSY, TOCSY, NOESY, or ROESY, or any combination thereof. In some embodiments, the glycosidic linkages are determined and/or detected, at least in part, by proton NMR. In some embodiments, the glycosidic linkages are determined and/or detected, at least in part, by carbon NMR. In some embodiments, the glycosidic linkages are determined and/or detected, at least in part, by 2D HSQC NMR.

In some embodiments, an oligosaccharide preparation may comprise one or more α-(1,2) glycosidic linkages, α-(1,3) glycosidic linkages, α-(1,4) glycosidic linkages, α-(1,6) glycosidic linkages, β-(1,2) glycosidic linkages, β-(1,3) glycosidic linkages, β-(1,4) glycosidic linkages, β-(1,6) glycosidic linkages, α(1,1)α glycosidic linkages, α(1,1)β glycosidic linkages, β(1,1)β glycosidic linkages, or any combination thereof.

In some embodiments, the oligosaccharide preparations have a glycosidic bond type distribution of about from 0 to 60 mol %, 5 to 55 mol %, 5 to 50 mol %, 5 to 45 mol %, 5 to 40 mol %, 5 to 35 mol %, 5 to 30 mol %, 5 to 25 mol %, 10 to 60 mol %, 10 to 55 mol %, 10 to 50 mol %, 10 to 45 mol %, 10 to 40 mol %, 10 to 35 mol %, 15 to 60 mol %, 15 to 55 mol %, to 50 mol %, 15 to 45 mol %, 15 to 40 mol %, 15 to 35 mol %, 20 to 60 mol %, 20 to 55 mol %, 20 to 50 mol %, 20 to 45 mol %, 20 to 40 mol %, 20 to 35 mol %, 25 to 60 mol %, 25 to mol %, 25 to 50 mol %, 25 to 45 mol %, 25 to 40 mol %, or 25 to 35 mol % of α-(1,6) glycosidic linkages.

### Molecular Weight

The molecular weight and molecular weight distribution of the oligosaccharide preparation may be determined by any suitable analytical means and instrumentation, such as end group method, osmotic pressure (osmometry), ultracentrifugation, viscosity measurements, light scattering method, SEC, SEC-MALLS, FFF, A4F, HPLC, and mass spectrometry. In some embodiments, the molecular weight and molecular weight distribution are determined by mass spectrometry, such as MALDI-MS, LC-MS, or GC-MS. In some embodiments, the molecular weight and molecular weight distribution are determined by size exclusion chromatography (SEC), such as gel permeation chromatography (GPC). In other embodiments, the molecular weight and molecular weight distribution are determined by HPLC. In some embodiments, the molecular weight and molecular weight distribution are determined by MALDI-MS.

In some embodiments, the weight average molecular weight of the preparation is about from 100 to 10000 g/mol, 200 to 8000 g/mol, 300 to 5000 g/mol, 500 to 5000 g/mol, 700 to 5000 g/mol, 900 to 5000 g/mol, 1100 to 5000 g/mol, 1300 to 5000 g/mol, 1500 to 5000 g/mol, 1700 to 5000 g/mol, 300 to 4500 g/mol, 500 to 4500 g/mol, 700 to 4500 g/mol, 900 to 4500 g/mol, 1100 to 4500 g/mol, 1300 to 4500 g/mol, 1500 to 4500 g/mol, 1700 to 4500 g/mol, 1900 to 4500 g/mol, 300 to 4000 g/mol, 500 to 4000 g/mol, 700 to 4000 g/mol, 900 to 4000 g/mol, 1100 to 4000 g/mol, 1300 to 4000 g/mol, 1500 to 4000 g/mol, 1700 to 4000 g/mol, 1900 to 4000 g/mol, 300 to 3000 g/mol, 500 to 3000 g/mol, 700 to 3000 g/mol, 900 to 3000 g/mol, 1100 to 3000 g/mol, 1300 to 3000 g/mol, 1500 to 3000 g/mol, 1700 to 3000 g/mol, 1900 to 3000 g/mol, 2100 to 3000 g/mol, 300 to 2500 g/mol, 500 to 2500 g/mol, 700 to 2500 g/mol, 900 to 2500 g/mol, 1100 to 2500 g/mol, 1300 to 2500 g/mol, 1500 to 2500 g/mol, 1700 to 2500 g/mol, 1900 to 2500 g/mol, 2100 to 2500 g/mol, 300 to 1500 g/mol, 500 to 1500 g/mol, 700 to 1500 g/mol, 900 to 1500 g/mol, 1100 to 1500 g/mol, 1300 to 1500 g/mol, 2000-2800 g/mol, 2100-2700 g/mol, 2200-2600 g/mol, 2300-2500 g/mol, or 2320-2420 g/mol. In some embodiments, the weight average molecular weight of the preparation is about from 2000 to 2800 g/mol, 2100 to 2700 g/mol, 2200 to 2600 g/mol, 2300 to 2500 g/mol, or 2320 to 2420 g/mol.

### Types of Oligosaccharides

In some embodiments, the species of oligosaccharides present in an oligosaccharide preparation may depend on the type of the one or more feed sugars. For example, in some embodiments, the oligosaccharide preparations comprise a gluco-oligosaccharide when the feed sugars comprise glucose. For example, in some embodiments, the oligosaccharide preparations comprise a galacto-oligosaccharide when the feed sugars comprise galactose. For another example, in some embodiments, the oligosaccharide preparations comprise gluco-galacto-oligosaccharides when the feed sugars comprise galactose and glucose.

In some embodiments, the oligosaccharide preparations comprise one or more species of monosaccharide subunits. In some embodiments, the oligosaccharide 5 preparation may comprise oligosaccharides with 1, 2, 3, 4, 5, 6, 7, 8, 9, 10, 11, 12, 13, 14, 15, 16, 17, 18, 19, 20, or more different species of monosaccharides subunits.

### Method of Manufacturing Oligosaccharide Preparations

The Method of manufacturing an oligosaccharide preparation according to the invention is described in detail in WO 2020/097458 comprising heating an aqueous composition comprising one or more feed sugars and a catalyst to a temperature and for a time sufficient to induce polymerization, wherein the catalyst is selected from the group consisting of: (+)-camphor-10-sulfonic acid; 2-pyridinesulfonic acid; 3-pyridinesulfonic acid; 8-hydroxy-5-quinolinesulfonic acid hydrate; α-hydroxy-2-pyridinemethanesulfonic acid; (β-camphor-10-sulfonic acid; butylphosphonic acid; diphenylphosphinic acid; hexylphosphonic acid; methylphosphonic acid; phenylphosphinic acid; phenylphosphonic acid; tert-butylphosphonic acid; SS)-VAPOL hydrogenphosphate; 6-quinolinesulfonic acid, 3-(1-pyridinio)-1-propanesulfonate; 2-(2-pyridinyl)ethanesulfonic acid; 3-(2-pyridyl)-5,6-diphenyl-1,2,4-triazine-p,p′-disulfonic acid monosodium salt hydrate; 1,1′-binaphthyl-2,2′-diyl-hydrogenphosphate, bis(4-methoxyphenyl)phosphinic acid; phenyl(3,5-xylyl)phosphinic acid; L-cysteic acid monohydrate; poly(styrene sulfonic acid-co-divinylbenzene); lysine; Ethanedisulfonic acid; Ethanesulfonic acid; Isethionic acid; Homocysteic acid; HEPBS (N-(2-Hydroxyethyl)piperazine-N′-(4-butanesulfonic acid)); HEPES (4-(2-hydroxyethyl)-1-piperazineethanesulfonic acid); 2-Hydroxy-3-morpholinopropanesulfonic acid; 2-(N-morpholino)ethanesulfonic acid; Methanesulfonic acid; Methaniazide; Naphthalene-1-sulfonic acid; Naphthalene-2-sulfonic acid; Perfluorobutanesulfonic acid; 6-sulfoquinovose; Triflic acid; 2-aminoethanesulfonic acid; Benzoic acid; Chloroacetic acid; Trifluoroacetic acid; Caproic acid; Enanthic acid; Caprylic acid; Pelargonic acid; Lauric acid; Pamitic acid; Stearic acid; Arachidic acid; Aspartic acid; Glutamic acid; Serine; Threonine; Glutamine; Cysteine; Glycine; Proline; Alanine; Valine; Isoleucine; Leucine; Methionine; Phenylalanine; Tyrosine; Tryptophan.

In some embodiments, the polymerization of the feed sugars is achieved by a step-growth polymerization. In some embodiments, the polymerization of the feed sugars is achieved by polycondensation.

### Feed Sugar

The one or more feed sugars used in the methods of manufacturing oligosaccharide preparations described herein may comprise one or more types of sugars. In some embodiments, the one or more feed sugars comprise monosaccharides, disaccharides, trisaccharides, tetrasaccharides, or any mixtures thereof.

In some embodiments, the one or more feed sugars comprise glucose. In some embodiments, the one or more feed sugars comprise glucose and galactose. In some embodiments, the one or more feed sugars comprise glucose, xylose, and galactose. In some embodiments, the one or more feed sugars comprise glucose and mannose. In some embodiments, the one or more feed sugars comprise glucose and fructose. In some embodiments, the one or more feed sugars comprise glucose, fructose, and galactose. In some embodiments, the one or more feed sugars comprise glucose, galactose, and mannose.

### III. Nutritional Composition Comprising Oligosaccharide Preparations

Provided herein are solid nutritional compositions (powderous formulations) comprising an oligosaccharide preparation.

As mentioned above, it has been surprisingly found that an oligosaccharide preparation according to the invention is effectively formulated if absorbed on a silica based product having an average particle size D of ≤3000 μm, for example ≤800 μm preferably ≤500 μm, more preferably ≤350 μm. It has also been found that the oligosaccharide preparation according to the invention is effectively formulated if absorbed on a silica based product having an average particle size D of at least 50 μm, preferably at least 100 μm.

Thus, in a first embodiment the present invention relates to a powderous formulation characterized by
(i) at least 20 weight-% (wt-%), based on the total weight of the powderous formulation, of an oligosaccharide preparation comprising at least n fractions of oligosaccharides each having a distinct degree of polymerization selected from 1 to n (DP1 to DPn fractions), wherein n is an integer greater or equal to 2; and wherein each fraction comprises from 1% to 90% anhydro-subunit containing oligosaccharides by relative abundance as measured by mass spectrometry,
(ii) 0 to 25 wt-%, based on the total weight of the powderous formulation, of water and/or an additive, and
(iii) at least 25 wt-%, based on the total weight of the powderous formulation, of a silica based adsorbate having an average particle size D 3000 μm.

In a second embodiment the present invention relates to a powderous formulation characterized by
(i) at least 20 weight-% (wt-%), based on the total weight of the powderous formulation, of an oligosaccharide preparation comprising at least n fractions of oligosaccharides each having a distinct degree of polymerization selected from 1 to n (DP1 to DPn fractions), wherein n is an integer greater or equal to 2; and wherein each fraction comprises from 1% to 90% anhydro-subunit containing oligosaccharides by relative abundance as measured by mass spectrometry,
(ii) 0 to 25 wt-%, based on the total weight of the powderous formulation, of water and/or an additive, and
(iii) at least 25 wt-%, based on the total weight of the powderous formulation, of a silica based adsorbate having an average particle size D 1200 μm.

The particle sizes as given herein can be measured by a Malvern Master Sizer 2000 following the recommendations outlined in ISO13320-1 for particle size analysis via laser diffraction methods (laser diffraction light scattering). During this laser diffraction measurement, particles are passed through a focused laser beam. The particles scatter light at an angle that is inversely proportional to their size. The angular intensity of the scattered light is then measured by a series of photosensitive detectors. The map of scattering intensity versus angle is the primary source of information used to calculate the particle size. For the measurement of the product form according to the present invention a dry powder feeder (Malvern Scirocco) was used.

Advantageously, the silica based formulation according to the present invention reduces the sensitivity of the oligosaccharide preparation to water uptake (reduce sensitivity once absorbed by a factor 2-2.5) and is free flowable (the formulation shows a flowability (s/100/g) of >4) and therefore further increases handling and storage properties.

If required, the particle size of the product can be analyzed by sieving. For this purpose, a minimum of 50 g are used. The product is placed on a sieving tower and then let it sieve for 5 min, setting the amplitude to 1.00 mm. The minimum mesh size was at least 0.1 mm.

The term additive as used herein refers to additives commonly used in the preparation of powderous formulations for feed application such as in particular to thickeners, such as in particular gums or cellulose derivatives such as xanthan gum, karaya gum and/or ethylcellulose. The additive can also be an edible solvent for the oligosaccharide preparation.

Preferred embodiments of the present invention are formulations characterized by
(i) 25 to 75 wt-%, based on the total weight of the powderous formulation, of an oligosaccharide preparation comprising at least n fractions of oligosaccharides each having a distinct degree of polymerization selected from 1 to n (DP1 to DPn fractions), wherein n is an integer greater than 2; and wherein each fraction comprises from 1% to 90% anhydro-subunit containing oligosaccharides by relative abundance as measured by mass spectrometry,
(ii) 0 to 25 wt-%, based on the total weight of the powderous formulation, of water and/or an additive, and
(iii) 20 to 75 wt-%, based on the total weight of the powderous formulation, of a silica based adsorbate having an average particle of at least 10 μm, preferably of at least 50 μm.

A more preferred embodiment of the present invention relates to a formulation consisting of
(i) 30 to 70 wt-%, based on the total weight of the powderous formulation, of a synthetic oligosaccharide preparation comprising at least n fractions of oligosaccharides each having a distinct degree of polymerization selected from 1 to n (DP1 to DPn fractions), wherein n is an integer greater or equal to 2; and wherein each fraction comprises from 1% to 90% anhydro-subunit containing oligosaccharides by relative abundance as measured by mass spectrometry,
(ii) 30 to 65 wt-%, based on the total weight of the powderous formulation, of a silica based adsorbate having an average particle size of at least 10 μm, preferably of at least 50 μm,
(iii) 0 to 21 wt-%, based on the total weight of the powderous formulation, of water.

Generally, to produce a powder according to the present invention the oligosaccharide preparation is optionally diluted in an edible solvent and further optionally admixed with additional additive(s), sprayed onto or admixed with a silica according to the present invention.

Preferred examples of an edible solvent to be used for diluting the oligosaccharide preparation are water, alcohol, and mixture off both and optionally additional additives are preservatives like sodium benzoate, citric acid.

The powderous formulation according to the present invention can additionally be coated with customary coatings in the art such as wax or fats. If present, such coating is generally applied in amounts of 5 to 50 wt.-% based on the total weight of the powderous form. Advantageously, the coating comprises at least one wax and/or at least one fat, which has a dropping point of from 30 to 85° C.

The dropping point of a material as used herein refers to the temperature (in ° C.) when the material begins to melt under standardized conditions. Thus the material is heated so long until it changes the state of matter from solid to liquid. The dropping point is the temperature when the first dropping is released from the material. The determination of the dropping point (Tropfpunkt) is carried out as described in the standard norm DIN ISO 2176.

Particularly suitable waxes to be used as coating in the context of the present invention include organic compounds consisting of long alkyl chains, natural waxes (plant, animal) which are typically esters of fatty acids and long chain alcohols as well as synthetic waxes, which are long-chain hydrocarbons lacking functional groups.

Particularly suitable fats to be used as coating in the context of the present invention include a wide group of compounds which are soluble in organic solvents and largely insoluble in water such as hydrogenated fats (or saturated fats) which are generally triesters of glycerol and fatty acids. Suitable fats can have natural or synthetic origin. It is possible to hydrogenate a (poly)unsaturated fat to obtain a hydrogenated (saturated) fat.

Preferred examples of waxes and fats to be used as coating according to the present invention are glycerine monostearate, carnauba wax, candelilla wax, sugarcane wax, palmitic acid, stearic acid hydrogenated cottonseed oil, hydrogenated palm oil and hydrogenated rapeseed oil as well as mixtures thereof.

All the above disclosed formulations can be used as such or in feed products.

In another embodiment, the invention relates to the use of silica based products as defined above having an average particle size D(v, 0.5) of ≤800 μm, preferably having a D(v, 0.5) selected in the range of 200 to 500 μm, more preferably in the range of 200 to 400 μm to enhance storage stability and handling properties (reduced sensitivity to water uptake and stable flowability) of the oligosaccharide composition.

Preferably, the amount of the formulation in the feed product is selected such, that the oligosaccharide preparation is present in the animal feed at a concentration of from about 1 to about 10000 ppm, from about 1 to about 5000 ppm, from about 1 to about 3000 ppm, from about 100 to about 3000 ppm, from about 100 to about 2000 ppm, from about 100 to about 1000 ppm, from about 100 to about 500 ppm, from about 100 to about 400 ppm.

The term feed product refers in particular to poultry and swine feed compositions as well as to feed additives.

The invention is illustrated by the following Examples.

### EXAMPLES

### Example 1: Synthesis of a Gluco-Galacto-Oligosaccharide Preparation

Synthesis of a gluco-galacto-oligosaccharide preparation was performed in a three-liter reaction vessel using catalyst loadings, reaction times, and reaction temperatures that were selected to enable suitable production at the kg scale.

D-glucose monohydrate (825.16 g), D-lactose monohydrate (263.48 g) and 2-pyridinesulfonic acid (1.0079 g, Sigma-Aldrich, St. Louis, US) were added to a three-liter, three-neck round bottom flask with a center 29/42 ground glass joint and two 24/40 side ground glass joints. A 133 mm Teflon stirring blade was affixed to a glass stir shaft using PTFE tape. The stir rod was secured through the center point using a Teflon bearing adapter and attached to an overhead high-torque mechanical mixer via flexible coupler. The flask was secured inside a hemispherical electric heating mantle operated by a temperature control unit via a J-type wand thermocouple inserted through a rubber septum in one of the side ports. The tip of the thermocouple was adjusted to reside within the reaction mixture with several mm clearance above the mixing element. A secondary temperature probe connected to an auxiliary temperature monitor was also inserted and secured by the same means. The second side port of the flask was equipped with a reflux condenser cooled by a water-glycol mixture maintained below 4° C. by a recirculating bath chiller.

The reaction mixture was gradually heated to 130° C. with continuous mixing with a stir rate of 80-100 rpm. When the reaction mixture reached 120° C., the reflux condenser was re-positioned into a distillation configuration, with the distillated collected in a 250 mL round bottom flask placed in an ice bath. The mixture was maintained at 130° C. with continuous mixing for 6 hours, after which the thermocouple box was powered off. The distillation apparatus was removed and 390 g of 60° C. distilled water was gradually added into the three-neck flask. The resulting mixture was left to stir at 40 RPM for 10 hours. Approximately 1,250 g of a viscous, light-amber material was collected and measured by refractive index to have a concentration of 71.6 Brix.

### Example 2: Synthesis of a Gluco-Oligosaccharide Preparation

Synthesis of a gluco-oligosaccharide preparation was performed in a three-liter reaction vessel using catalyst loadings, reaction times, and reaction temperatures that were selected to enable suitable production at the kg scale.

D-glucose monohydrate (1,150 g) was added to a three-liter, three-neck round bottom flask with one center 29/42 ground glass joint and two side 24/40 ground glass joints. A 133 mm Teflon stirring blade was affixed to glass stir shaft using PTFE tape. The stir rod was secured through the center port of the flask using a Teflon bearing adapter and attached to an overhead high-torque mechanical mixer via flex coupling. The flask was secured inside a hemispherical electric heating mantle operated by a temperature control unit via a J-type wand thermocouple inserted through a rubber septum in one of the side ports. The tip of the thermocouple was adjusted to reside within the reaction mixture with several mm clearance above the mixing element. A secondary temperature probe connected to an auxiliary temperature monitor was also inserted and secured by the same means. The second side port of the flask was equipped with a reflux condenser cooled by a water-glycol mixture maintained below 4° C. by a recirculating bath chiller.

The reaction mixture was gradually heated to 130° C. with continuous mixing with a stir rate of 80-100 rpm. When the reaction temperature increased to between 120° C. and 130° C., (+)-Camphor-10-sulfonic acid (1.16 g, Sigma-Aldrich, St. Louis) was added to the three-neck flask and the apparatus was switched from a reflux condenser to a distillation configuration with a round bottom collection flask placed in an ice bath. This setup was maintained for 1 and a half hours, after which the thermocouple box was powered off, the distillation apparatus was removed, and 390 g of 23° C. distilled water was gradually added into the three-neck flask. The resulting mixture was left to stir at 40 rpm for 10 hours until the moment of collection. Approximately 1300 g of a viscous, dark-amber material was collected and measured to have a concentration of 72.6 brix.

### Example 3: Synthesis of a Gluco-Manno-Oligosaccharide Preparation

Synthesis of a gluco-oligosaccharide preparation was performed in a three-liter reaction vessel using catalyst loadings, reaction times, and reaction temperatures that were selected to enable suitable production at the kg scale.

A gluco-manno-oligosaccharide preparation was prepared as two separate components synthesized in separate reaction vessels that were independently collected. Each synthesis used different starting reactants but followed the same procedure and methods to completion. The final gluco-manno-oligosaccharide preparation was a homogeneous syrup formed from the mixing of both synthesis products.

For the synthesis of the first component, 1264.80 g of glucose monohydrate was added to a three-liter, three-neck round bottom flask with one center 29/42 ground joint flanked by two 24/40 ground joints. A 133 mm Teflon stirring blade was affixed to a 440 mm glass stir shaft using PTFE tape. The stir rod was secured through the center point using a Teflon bearing adapter and attached to an overhead high-torque mechanical mixer via flexible coupler. The flask was placed inside a hemispherical electric heating mantle operated by a temperature control unit via a J-type wand thermocouple inserted through a rubber septum in one of the side ports. The tip of the thermocouple was adjusted to reside within the reaction mixture with several mm clearance above the mixing element. A secondary temperature probe connected to an auxiliary temperature monitor was also inserted and secured by the same means. The second side port of the flask was equipped with a reflux condenser cooled by a water-glycol mixture maintained below 4° C. by a recirculating bath chiller.

The reaction mixture was gradually heated to 130° C. with continuous mixing with a stir rate of 80-100 rpm. Once a temperature control box reading between 120° C. and 130° C. was observed, 1.15 g of (+)-camphor-10-sulfonic acid was added to the three-neck flask and the apparatus was switched from a reflux condenser to a distillation configuration with a round bottom collection flask placed in an ice bath. This setup was maintained for approximately 1 hour, after which the thermocouple box was powered off, the distillation apparatus was removed, and 390 g of 23° C. distilled water was gradually added into the three-neck flask. The resulting mixture was left to stir at 40 rpm for 10 hours until the moment of collection. Approximately 1350 g of a viscous, light-amber material was collected and measured to have a concentration of 71.8 brix.

For the synthesis of the second component, 949.00 g of glucose monohydrate, 288.00 g of pure mannose from wood, 27.94 g distilled water, and 1.15 g of 2-pyridinesulfonic acid were added to a three-liter, three-neck round bottom flask with one center 29/42 ground joint flanked by two 24/40 ground joints. The remainder of the second component's synthesis followed the same procedure and methods as those of the first until the moment of collection, except (+)-camphor-10-sulfonic acid was not added as the reflux condenser was switched to a distillation configuration and the resulting setup was maintained for approximately 6 hours. Approximately 1350 g of a viscous, dark-amber material was collected and measured to have a concentration of 72.0 brix.

The entirety of the first and second components were transferred into a suitably sized HDPE container and mixed thoroughly by hand until homogenous. The final syrup mixture was approximately 2.7 kg, dark-amber in color, viscous and was measured by refractive index to have a concentration of approximately 72 Brix.

### Example 4: Synthesis of a Gluco-Manno-Oligosaccharide Preparation

Kilogram scale production of the oligosaccharide preparation was performed in a three-liter reaction vessel using catalyst loadings, reaction times, and reaction temperatures found to be suitable for production at the 1 kg scale.

A gluco-manno-oligosaccharide preparation was prepared as two separate components synthesized in separate reaction vessels that were independently collected. Each synthesis used different starting reactants but followed the same procedure and methods to completion. The final gluco-manno-oligosaccharide preparation was a homogeneous syrup formed from the mixing of both synthesis products.

For the synthesis of the first component, 1261.00 g of glucose monohydrate and 1.15 g of 2-pyridinesulfonic acid were added to a three-liter, three-neck round bottom flask with one center 29/42 ground joint flanked by two 24/40 ground joints. A 133 mm Teflon stirring blade was affixed to a 440 mm glass stir shaft using PTFE tape. The stir rod was secured through the center point using a Teflon bearing adapter and attached to an overhead high-torque mechanical mixer via flexible coupler. The flask was secured inside a hemispherical electric heating mantle operated by a temperature control unit via a J-type wand thermocouple inserted through a rubber septum in one of the side ports. The tip of the thermocouple was adjusted to reside within the reaction mixture with several mm clearance above the mixing element. A secondary temperature probe connected to an auxiliary temperature monitor was also inserted and secured by the same means. The second side port of the flask was equipped with a reflux condenser cooled by a water-glycol mixture maintained below 4° C. by a recirculating bath chiller.

The reaction mixture was gradually heated to 130° C. with continuous mixing with a stir rate of 80-100 rpm. Once a temperature control box reading between 120° C. and 130° C. was observed, the apparatus was switched from a reflux condenser to a distillation configuration with a round bottom collection flask placed in an ice bath. This setup was maintained for approximately 6 hours, after which the thermocouple box was powered off, the distillation apparatus was removed, and 390 g of 23° C. distilled water was gradually added into the three-neck flask. The resulting mixture was left to stir at 40 rpm for 10 hours until the moment of collection. Approximately 1250 g of a viscous, light-amber material was collected and measured to have a concentration of 73.5 brix.

For the synthesis of the second component, 949.00 g of glucose monohydrate, 288.00 g of pure mannose from wood, 28.94 g distilled water, and 1.15 g of 2-pyridinesulfonic acid were added to a three-liter, three-neck round bottom flask with one center 29/42 ground joint flanked by two 24/40 ground joints. The remainder of the second component's synthesis followed the same procedure and methods as those of the first until the moment of collection. Approximately 1250 g of a viscous, dark-amber material was collected and measured to have a concentration of 73.3 brix.

The entirety of the first and second components were transferred into a suitably sized HDPE container and mixed thoroughly by hand until homogenous. The final syrup mixture was approximately 2.5 kg, dark-amber in color, viscous and was measured to have a concentration of approximately 73 brix.

### Example 5: Synthesis of a Gluco-Galacto-Oligosaccharide Preparation

Kilogram scale production of the oligosaccharide preparation was performed in a three-liter reaction vessel using catalyst loadings, reaction times, and reaction temperatures found to be suitable for production at the 1 kg scale.

A 3 L three-neck flask was equipped with an overhead mixer connected via a 10 mm diameter glass stir-shaft to a 14 cm crescent-shaped mixing element. The mixing element was positioned with approximately 5 mm clearance from the walls of the flask. The flask was heated via a hemispherical electric heating mantle powered by a temperature control unit connected to a wand-type thermocouple probe inserted into the reaction flask. The thermocouple probe was placed to provide 5-10 mm clearance above the mixing element. The flask was charged with 576 grams of food-grade dextrose monohydrate and 577 grams of food-grade D-galactose monohydrate and heated to approximately 115° C. to obtain a molten sugar syrup. Once the syrup was obtained, the flask was fitted with a jacketed reflux condenser cooled to 4° C. by circulating chilled glycol/water and the temperature. 31 grams of Dowex Marathon C (moisture content 0.48 g H₂O/g resin) were added to the mixture to form a stirred suspension. The condenser was repositioned into distillation configuration and the suspension was heated to 145° C.

A mixing rate of approximately 80 RPM and a temperature of 145° C. was maintained for 3.8 hours, after which the set point on the temperature control unit was reduced to 80° C. and 119 mL of 60° C. deionized water was gradually added to the flask to obtain a dark amber syrup containing residual Dowex resin. The resulting suspension was further diluted to 60 Brix, cooled to room temperature and vacuum filtered through a 0.45 micron filter to remove the resin. 1,200 grams of light-amber syrup at 60 Brix concentration was obtained.

### Example 6: Synthesis of a Gluco-Oligosaccharide Preparation

Kilogram scale production of the oligosaccharide preparation was performed in a three-liter reaction vessel using catalyst loadings, reaction times, and reaction temperatures found to be suitable for production at the 1 kg scale.

A 3 L three-neck flask was equipped with an overhead mixer connected via a 10 mm diameter glass stir-shaft to a 14 cm crescent-shaped mixing element. The mixing element was positioned with approximately 5 mm clearance from the walls of the flask. The flask was heated via a hemispherical electric heating mantle powered by a temperature control unit connected to a wand-type thermocouple probe inserted into the reaction flask. The thermocouple probe was placed to provide 5-10 mm clearance above the mixing element. The flask was gradually charged with 1,148 grams of food-grade dextrose monohydrate and heated to approximately 115° C. to obtain a molten sugar syrup. Once the syrup was obtained, the flask was fitted with a jacketed distillation condenser cooled to 4° C. by circulating chilled glycol/water. The reaction temperature was gradually increased to 145° C. Once the temperature was obtained and stable, 31 grams of Dowex Marathon C (moisture content 0.48 g H₂O/g resin) was added to the mixture and a mixing rate of approximately 80 RPM and a temperature of 145° C. was maintained for 3.8 hours.

After 3.8 hours, the set point on the temperature control unit was reduced to 80° C. and 119 mL of 60° C. deionized water was gradually added to the flask to obtain a dark amber syrup containing residual Dowex resin. The resulting suspension was further diluted to 60 Brix, cooled to room temperature and vacuum filtered through a 0.45 micron filter to remove the resin. 1,113 grams of dark-amber gluco-oligosaccharide syrup at 60 Brix concentration was obtained.

### Example 7: Synthesis of a Solid Oligosaccharide Preparations

Particle size determination: The methodology described below followed the recommendations outlined in ISO13320-1 for diffraction light scattering techniques.

The particle sizes of various silica grades can be measured by a Malvern Master Sizer 2000 following the recommendation of 15013320-1 for diffraction light scattering techniques. An aliquot of minimum 5 grams of the material tempered at 25° C.-35 to 55% r.H is sampled into the vibrator hopper of the dry dispersion unit (Sirocco). The flow aperture of the dispenser gate is set up on the way that the product flows for 30 seconds through the measurement zone using a tygon tube, at a vibration feed rate of 50%. A sample measurement at 0.1 bar of disperser pressure is taken for 30 seconds and a snap of 30000. The sample pass through the focused beams of light (Helium-neon laser for the red light and solid state light source for the blue) and scatter the light allowing a measurement of particles between 0.02 and 2000 micrometers. The medium particle diameter in volume, d(0.5), is determined using Fraunhofer approximation.

Preparation of the formulation: As outlined in table 1 different types of oligosaccharide preparations (syrup) according to examples 1-9, optionally pre-heated, are added under gentle agitation to a silica based adsorbate, mixed in a mixer (standard mixer as for example conical screw mixer, paddle mixer or screw mixer) until the adsorption is completed and a free flowing powder is obtained.

TABLE 1

| | | Temp. | Mixing | | | | |
|---|---|---|---|---|---|---|---|
| | Carrier Type¹ | Syrup² | Temp. | Way of | Mix Time³ | Vac.⁴ | |
| Preparation | Particle Size | (° C.) | Solid (° C.) | addition | (min) | (mbar) | C:S⁵ |
| T1 | DE | 65 | RT | Poured | 60 | no | 60/40 |
| | D = 510 μm | | | | | | |
| T2 | DE | 65 | RT | Poured | 20 | −500 | 60/40 |
| | D = 510 μm | | | | | | |
| T3 | DE | 20 | RT | Poured | 5 | No | 60/40 |
| | D = 510 μm | | | | | | |
| T4 | DE | 40 | RT | Poured | 30 | No | 60/40 |
| | D = 510 μm | | | | | | |
| T5 | DE | 35 | RT | Poured | 7 | No | 55/45 |
| | D = 510 μm | | | | | | |
| T6 | DE | 50 | RT | Poured | 10 | −900 | 60/40 |
| | D = 510 μm | | | | | | |
| T7 | DE | 50 | RT | sprayed | 10 | −850 | 55/45 |
| | D = 510 μm | | | | | | |
| T8 | DE | 50 | RT | poured | 10 | no | 60/40 |
| | D = 510 μm | | | | | | |
| T9 | AS | RT | RT | Poured | 15 | no | 35/65 |
| | D = 355 μm | | | | | | |

1: Silica based adsorbate: DE = Diatomaceous earth/AS = amorphous precipitated silica D = average particle size (D 0.5)
2: Optionally pre-heated syrup before mixing
3: Mixing time (post adding)
4: Mixing with or without vacuum
5: Carrier/Syrup Ratio added

Physical properties are shown in Table 2.

The silica based formulation according to the present invention reduces the sensitivity of the oligosaccharide preparation to water uptake (reduce sensitivity once absorbed by a factor 2-2.5) and is free flowable (the formulation shows a flowability (s/100/g) of >4) and therefore further increases handling and storage properties.

TABLE 2

| | | Dusting | Flowability | Theoretical |
|---|---|---|---|---|
| Preparation | Loading¹ | (mg/25 g) | (s/100 g) | water content |
| T1 | 28% | Very low | High 8 | 12 |
| T2 | 28% | Very low | High 9 | 12 |
| T3 | 28% | Very low | X | 12 |
| T4 | 28% | Very low | X | 12 |
| T5 | 35.5% | Very low | X | 15 |
| T9 | 45.5% | X | X | 19.5 |

¹Declared Oligosaccharide content

### Example 8: Evaluation of the Physical Stability of Oligosaccharide Adsorbates

The storage behaviour of two adsorbates containing a fixed level of oligosaccharides have been evaluated. The material as described in Table 3 was used for testing. Description was performed at room temperature.

TABLE 3
Manufacturing parameters used for the
production of the tested material

| | | Estimate | Process Conditions | |
|---|---|---|---|---|
| Preparation | Carrier | content (%) | Temp./Total Mixing | Description |
| T1 | AS | 45.5 | RT/20 min | Flowing |
| | | | | powder |
| T2 | AS | 45.5 | RT/30 min | Flowing |
| | | | | powder |

AS = amorphous precipitated silica

Methods

A climatic chamber set to 52.5° C. and 60% rH was used to test the physical stability of the powders. Evaluation was done visually.

Results

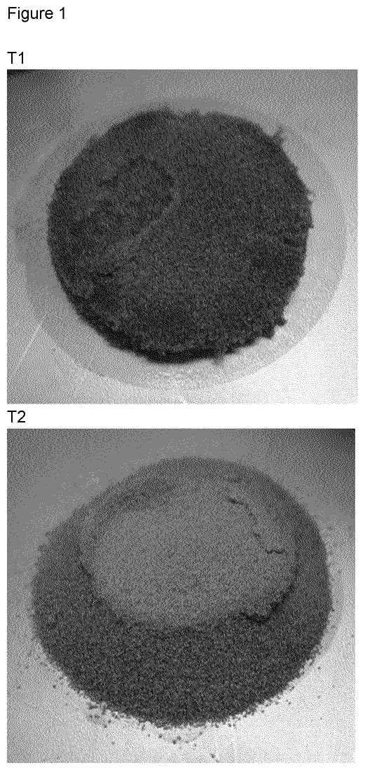

Samples were stored in a climatic chamber for 3 days in conditions of 52.5° C. and rH of 60%. Evaluation of the state of the powder (molten/sticky or powdery) was performed after the elapsed period. Results can be observed in FIG. 1.

FIG. 1 shows the material after exposure to the test conditions. T1 material showed evidence of release of adsorbed fluid resulting in a dough like consistency. Particles stick together forming a soft lump difficult to handle. Some of the fluid seem to be released and forms a ring around the lump (arrow). T2 material exposed to the same conditions showed unchanged characteristics. The powder remained flowable and the individual particles did not change structure nor melted/sticked each other. Surprisingly, by using same carrier with the same amount of fluid, an stabilizing effect can be observed by modifying the conditions on which the powder is manufactured.

### Example 9: Synthesis of a Solid Oligosaccharide Preparation with In-Process Solids Heating

Oligosaccharide preparations were adsorbed on diatomaceous earth under a variety of process conditions and loadings. It was determined that certain process conditions and loadings resulted in a stable, flowable powder form while certain process conditions resulted in an unacceptable product form.

Preparation of the formulation: oligosaccharide preparations were formulated onto powdered diatomaceous earth (Perma-Guard EGP-DE-50C fossil shell flour) having an average particle size of D=50 microns and an initial moisture content less than 5 wt %. A pre-determined mass of carrier material was charged into a 10 L, 600 W overhead planetary mixer unit. The mixing vessel was equipped with external heat tracing and a thermocouple to control the temperature of the solids to a pre-determined temperature set-point throughout the adsorption process. The oligosaccharide preparation was provided as an aqueous syrup with a concentration between about 60 wt % to about 70 wt % dissolved solids, as determined by calibrated refractive index. The aqueous oligosaccharide syrup was added gradually to the mixer by peristaltic pump, with a pre-determined pump flow rate. The temperature of the syrup was maintained at a pre-determined temperature set-point using an inline heat exchanger.

Five batch additions were performed under different process conditions of syrup temperature, mixer solids temperature, syrup concentration, and syrup addition rate as described in Table 4.

TABLE 4
Batch formulation process parameters

| | Syrup | Syrup | Syrup | Carrier | Mixing | Syrup |
|---|---|---|---|---|---|---|
| | Mass | Conc | Temp | Mass | Solids Temp | Flow |
| Example | (g) | (g/g) | (° C.) | (g) | (° C.) | (mL/min) |
| Ex. 9.1 | 1,120 | 63.7% | 40 | 1,294 | 30-40 | 38 |
| Ex. 9.2 | 1,435 | 64.3% | 60 | 1,000 | 50-60 | 53 |
| Ex. 9.3 | 1,432 | 66.7% | 60 | 1,201 | 50-60 | 3.5 |
| Ex. 9.4 | 722 | 66.6% | 60 | 429 | 50-60 | 14 |
| Ex. 9.5 | 718 | 67.0% | 60 | 431 | 50-60 | 2.4 |

Determination of Oligosaccharide Loading: the mass loading of oligosaccharide preparations onto the solid carrier was determined by extraction and refractive index as follows. An aliquot of about 1 gram (mass recorded to ±0.1 mg) was dispensed into a 15 mL conical centrifuge tube and suspended in 10.00 mL of de-ionized water. The suspension was mixed by vortex agitation for 30 seconds and allowed to sit for 10 minutes. The vortex agitation process was repeated two additional times. The resulting extract was centrifuged at 2,500 RPM for 10 minutes. The supernatant was removed by pipette and its carbohydrate content was determined by refractive index using a calibrated meter (Hanna Instruments HI196801, digital refractometer). The mass of dissolved oligosaccharide preparation was determined by reference to a standard calibration curve and the oligosaccharide content of the adsorbate was determined as the mass ratio of the extracted oligosaccharide preparation to the mass of the initial solid aliquot. Refractive index measurements were performed five replicate times, and the individual replicates were averaged to obtain the measurement result.

Determination of Moisture Content: the moisture content of the formulated adsorbates was determined gravimetrically by heating to constant weight or by moisture balance. For moisture balance determinations, an approximately 5 gram aliquot of the solid adsorbate was added to the tray of a halogen-heated instrument (Mettler Toledo HE53 moisture balance), with a final temperature setting of 120 degrees Celsius.

Determination of Hygroscopic Stability: the stability of the adsorbates to moisture absorption was determined by placing aliquots of the solid adsorbate into environmental chambers with a fixed temperature and water activity atmosphere. Four chambers were configured to measure hygroscopicity at 20 degrees Celsius and water activities of 0.378, 0.753, and 0.843 using saturated aqueous reservoirs of magnesium chloride, sodium bromide, sodium chloride, and potassium chloride, respectively. Moisture exchange of the form with its atmosphere was determined gravimetrically, and the final moisture content of each sample was determined after 14 days of equilibration. Final materials were evaluated visually for stickiness, clumping, aggregation, and for flowability through a 6 mm circular aperture.

Stability results were obtained as described in Table 5.

TABLE 5
Adsorbate Loading and Stability Properties

| | Loading | Moisture | Visual | Flowability | Hygroscopic |
|---|---|---|---|---|---|
| Example | (wt %) | (wt %) | Description | (qualitative) | Stability |
| Ex. 9.1 | 30% | 17.6% | off-white fine powder | good | Stable below |
| | | | | | 84.3% RH |
| Ex. 9.2 | 40% | 17.9% | wet, agglomerate | Poor | none |
| Ex. 9.3 | 42% | 7.2% | off-white, granular | Good | Stable below |
| | | | | | 75.3% RH |
| Ex. 9.4 | 48% | 10.4% | Wet, agglomerate | Poor | None |
| Ex. 9.5 | 50% | 7.5% | Off-white powder | Good | Stable below |
| | | | | | 57.6% RH |

Verification of Chemical Stability: Representative chemical structural properties of the oligosaccharide preparations were confirmed to be unchanged by the adsorption process. The number average molecular weight (Mn) and weight average molecular weight (Mw) of source oligosaccharide syrups and oligosaccharides extracted from the adsorbate were determined by size-exclusion high performance liquid chromatography (SEC/HPLC). A 1 Brix aqueous solution was injected into an Agilent 1100 series HPLC equipped with a gel permeation chromatography (GPC) column (Agilent PL aquagel-OH, 300×7.5 mm, #PL1120-6520, and corresponding guard column) at 40° C. with isocratic elution at 0.625 mL/min using 0.05% aqueous tri-fluoroacetic acid as the mobile phase and refractive index (RI) detection at 40° C. Molecular weights were determined against a calibration curve obtained using authentic pullulan standards with known Mn and Mw. The results of HPLC analysis for representative extractions are provided in Table 6.

Furthermore, the glycosidic linkage distribution of oligosaccharide preparations was determined by 2D ¹H-¹³C HSQC NMR spectroscopy and it was confirmed that the linkage distribution of oligosaccharide preparations extracted from the adsorbate were not measurably changed from that of the preparation prior to adsorption.

TABLE 6
Polymer Properties of Adsorbed Oligosaccharide Preparations

| | Mn | Mw | wt % |
|---|---|---|---|
| Material | (g/mol) | (g/mol) | Monomer |
| Prior to Adsorption | 763 ± 27 | 1162 ± 67 | 14.7% |
| Ex. 9.5 Aqueous Extract | 749 ± 27 | 1135 ± 67 | 14.8% |

### Example 10: Synthesis of a Solid Oligosaccharide Preparation by Spray Adsorption Using a Twin-Fluid Nozzle

An oligosaccharide preparations were adsorbed onto diatomaceous earth using a two-fluid spray nozzle without the need to heat the solids during adsorption, as in the method of Example 9. Hygroscopically stable, flowable powder forms were obtained with an oligosaccharide loading in excess of 40 wt % using two different size carriers.

Preparation of the formulation: the oligosaccharide preparation was formulated onto powdered diatomaceous earth using two different qualities: (1) EGP-DE-50C fossil shell flour (Perma-Guard, US) having an average particle size of D=50 microns, and (2) DIAMOL® DI10KF granular terracotta (Imerys, France) having a particle size spread of about 200-600 microns. A pre-determined mass of carrier material was charged into a 10 L, 600 W overhead planetary mixer unit. With continuous mixing at ambient temperature, the oligosaccharide preparation was delivered as a 70 wt % aqueous syrup atomized using an external mixing twin-fluid nozzle (BETE XAEF 100, BETE Fog Nozzle Inc, US) with pressurized air as the atomizing fluid. The airflow was to provide 10 kg of air per kg of syrup at a pressure of 40 psi (276 kPa) pressure drop in the nozzle. The syrup was added continuously until the desired loading was achieved. The oligosaccharide loadings and moisture contents of the resulting powder adsorbate formulations were determined using the methods of Example 9, as described in Table 7.

TABLE 7
Solid adsorbate preparations

| | Particle Size | Oligosaccharide | Moisture Content |
|---|---|---|---|
| | (micron) | Loading (wt %) | (wt % H2O) |
| Ex. 10.1 | 50 | 40.0% | 12.9% |
| Ex. 10.2 | 200-600 | 42.3% | 5% |

The flowability and hygroscopic stability of the two solid forms, Ex. 10.1 and Ex. 10.2, were confirmed using the methods described of Example 9.

### Example 11. Comparative Example Using Calcium Carbonate

The methods of Examples 9 and 10 were repeated using calcium carbonate (FGCC50, FCC grade powder, 325 mesh, Duda Energy, US) as the carrier material. No set of process conditions evaluated with syrup temperature between ambient to 80° C., solids mixing temperature between ambient and 90° C., air flow between 0.1 and 4 cfm, and air pressure between 5 and 50 psig, allowed a stable, flowable powder with more than 18 wt % oligosaccharide loading.

1. A storage-stable powderous formulation comprising
(i) at least 20 weight-% (wt-%), based on the total weight of the powderous formulation, of an oligosaccharide preparation comprising at least n fractions of oligosaccharides each having a distinct degree of polymerization selected from 1 to n (DP1 to DPn fractions), wherein n is an integer greater or equal to 2; and wherein each fraction comprises from 1% to 90% anhydro-subunit containing oligosaccharides by relative abundance as measured by mass spectrometry,
(ii) 0 to 25 wt-%, based on the total weight of the powderous formulation, of water and/or an additive, and
(iii) at least 25 wt-%, based on the total weight of the powderous formulation, of a silica based adsorbate having an average particle size D≤3000 μm.

2. A storage-stable powderous formulation comprising
(i) at least 20 weight-% (wt-%), preferably 25 to 75 weight-% (wt-%), based on the total weight of the powderous formulation, of an oligosaccharide preparation comprising at least n fractions of oligosaccharides each having a distinct degree of polymerization selected from 1 to n (DP1 to DPn fractions), wherein n is an integer greater or equal to 2; and wherein each fraction comprises from 1% to 90% anhydro-subunit containing oligosaccharides by relative abundance as measured by mass spectrometry,
(ii) 0 to 25 wt-%, based on the total weight of the powderous formulation, of water and/or an additive, and
(iii) 30 to 75 wt-%, based on the total weight of the powderous formulation, of a silica based adsorbate having an average particle size D≤1200 μm.

3. A storage-stable powderous formulation comprising
(i) 30 to 70 wt-%, based on the total weight of the powderous formulation, of a synthetic oligosaccharide preparation comprising at least n fractions of oligosaccharides each having a distinct degree of polymerization selected from 1 to n (DP1 to DPn fractions), wherein n is an integer greater or equal to 2; and wherein each fraction comprises from 1% to 90% anhydro-subunit containing oligosaccharides by relative abundance as measured by mass spectrometry,
(ii) 30 to 70 wt-%, based on the total weight of the powderous formulation, of a silica based adsorbate having an average particle size of at least 50 μm,
(iii) 0 to 21 wt-%, based on the total weight of the powderous formulation, of water.

4. The storage-stable powderous formulation according to claim 1, wherein the silica based adsorbate is amorphous precipitated silica (AS).

5. The storage-stable powderous formulation according to claim 1, wherein the silica based adsorbate is diatomaceous earth (DE).

6. The storage-stable powderous formulation according to claim 1, wherein the particle size D of the silica based adsorbate is selected in the range of 100 to 500 μm, preferably in the range of 200 to 500 μm.

7. The storage-stable powderous formulation according to claim 1, wherein the particle size D of the silica based adsorbate is selected preferably in the range of 200 to 300 μm.

8. The storage-stable powderous formulation according to claim 1, wherein the relative abundance of oligosaccharides in each of the n fractions decreases monotonically with its degree of polymerization.

9. The oligosaccharide preparation of claim 1, wherein n is at least 4, 5, 6, 7, 8, 9, 10, 11, 12, 13, 14, 15, 16, 17, 18, 19, 20, 21, 22, 23, 24, 26, 27, 28, 29, 30, 31, 32, 33, 34, 35, 36, 37, 38, 39, 40, 41, 42, 43, 44, 45, 46, 47, 48, 49, 51, 52, 53, 54, 55, 56, 57, 58, 59, 60, 61, 62, 63, 64, 65, 66, 67, 68, 69, 70, 71, 72, 73, 74, 76, 77, 78, 79, 80, 81, 82, 83, 84, 85, 86, 87, 88, 89, 90, 91, 92, 93, 94, 95, 96, 97, 98, 99, or 100.

10. The oligosaccharide preparation of claim 1, wherein at least one fraction comprises less than 80%, 70%, 60%, 50%, 40%, 30%, 20%, 19%, 18%, 17%, 16%, 15%, 14%, 13%, 12%, 11%, 10%, 9%, 8%, 7%, 6%, 5%, 4%, 3%, or 2% anhydro-subunit containing oligosaccharides by relative abundance.

11. The oligosaccharide preparation of claim 1, wherein at least one fraction comprises less than 10%, 9%, 8%, 7%, 6%, 5%, 4%, 3%, or 2% anhydro-subunit containing oligosaccharides by relative abundance.

12. The oligosaccharide preparation of claim 1, wherein each fraction comprises greater than 2%, 3%, 4%, 5%, 6%, 7%, 8%, 9%, 10%, 11%, 12%, 13%, 14%, 15%, 16%, 17%, 18%, 19%, 20%, 30%, 40%, 50%, 60%, 70%, or 80% anhydro-subunit containing oligosaccharides by relative abundance.

13. The oligosaccharide preparation of claim 1, wherein the weight average molecular weight of the preparation is about from 300 to 5000 g/mol, 500 to 5000 g/mol, 700 to 5000 g/mol, 500 to 2000 g/mol, 700 to 2000 g/mol, 700 to 1500 g/mol, 300 to 1500 g/mol, 300 to 2000 g/mol, 400 to 1300 g/mol, 400 to 1200 g/mol, 400 to 1100 g/mol, 500 to 1300 g/mol, 500 to 1200 g/mol, 500 to 1100 g/mol, 600 to 1300 g/mol, 600 to 1200 g/mol, or 600 to 1100 g/mol.

14. The oligosaccharide preparation of claim 1, wherein the weight average molecular weight of the preparation is about from 2000 to 2800 g/mol, 2100 to 2700 g/mol, 2200 to 2600 g/mol, 2300 to 2500 g/mol, or 2320 to 2420 g/mol.

15. The oligosaccharide preparation of claim 1, wherein the number average molecular weight of the preparation is about from 1000 to 2000 g/mol, 1100 to 1900 g/mol, 1200 to 1800 g/mol, 1300 to 1700 g/mol, 1400 to 1600 g/mol, or 1450 to 1550 g/mol.
